(19) United States
(12) Patent Application Publication
(10) Pub. No.: US 2003/0164264 A1
(43) Pub. Date: Sep. 4, 2003

(54) Structure for linear guideway

(76) Inventor: Bing-Hung Luo, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/086,420

(22) Filed: Mar. 4, 2002

(51) Int. Cl. F16N 1/00

(52) U.S. Cl. 184/5

(57) ABSTRACT

The present invention is mainly to provide an improved structure for linear guideway, which in general contains: an unlimitedly extendable guideway, a moving slider along the guideway, a slide way installed inside the slider for the movement of the rolling objects, an end cover installed at the end of the slide way for the rolling objects to circulate; among which a lubricating structure is installed longitudinally inside the slider and mainly contains an oil reservoir inside the slider, which oil reservoir extends to the two ends of the slider and connects to the slide way and has a diversion device inside, which diversion device is rather tough and long enough for contact with the most surface area of the rolling objects (FIG. 3).

### BACKGROUND OF THE INVENTION

According to FIG. 1, the traditional linear guideway with lubricating structure is in general composed of an unlimitedly extendable guideway 10 and a moving slider 20 along the guideway 10. Inside the slider 20, a slide way 30 is installed to accommodate rolling objects 31 (maybe steel ball structure). The slide way 30 contains a lubricating module 40 inside. At one end of the slide way 30, an end cover 50 is installed to allow the rolling objects 31 to circulate. The lubricating module 40 mainly contains an oil-containing substance 41 (could be oil-absorbing cotton cloth) that can contact the rolling objects 31. An oil-wiping blade 42 is located on one side of the oil-containing substance 41, while the slider is on the other side. Thus, for the traditional linear guideway, basically at the moment when the oil-containing substance 41 for the lubricating module 40 contacts the rolling objects 31, the lubricating oil is distributed all over the rolling objects 31. Then, through the rolling motion of the rolling objects 31 that have a certain lubricating effect, the slider 20 with a specific friction coefficient moves upward along the guideway 10. However, it is well known that since the rolling objects 31 is in spherical shape, when any liquid in a specific quantity contacts any point of the rolling objects 31, it will flow around the sphere to cover all the surface of the rolling objects 31. Nevertheless, it takes a certain time for the lubricating oil to flow all over the surface of the rolling objects 31. Further, it is very hard for the lubricating oil from the first contacting rolling object 31 to flow to other rolling objects 31 that do not contact the oil-containing substance 41. When the slider 20 moves back and forth within a very short time, only few rolling objects 31 get lubricated. Therefore, such traditional structure causes poor lubrication on the rolling objects 31, so poor rolling motion takes place and the friction coefficient increases. As a result, the frictional loss is increased and the slider 20 can not slide smoothly along the guideway 10. The disadvantage is clearly shown.

Further, lubricating structure for another traditional linear guideway is shown in FIG. 2. When its design is compared to that in FIG. 1, we clearly learn that it is made only with a change of the oil-containing substance 41 in FIG. 1 to an oil reservoir 43. The lubricating effect is still limited. Thus, how to design a lubricating structure to provide effective and rapid lubrication is an important subject that the relevant industry should work on.

### SUMMARY OF THE INVENTION

The objective of the present invention is to provide an improved structure for linear guideway, which in general contains an unlimitedly extendable guideway, a slider moving along the guideway, a slide way inside the slider to accommodate the rolling objects and an end cover installed at one end of the guideway for the rolling objects to circulate. Inside the slider, there is a lubricating structure, which mainly contains an oil reservoir extending to both ends of the slider and connecting to the guideway. Besides, inside the oil reservoir there is a diversion device, which has sufficient toughness and its length is sufficient for contact with most surface area of the rolling object.

### BRIEF DESCRIPTION OF THE DRAWINGS

The drawings disclose an illustrative embodiment of the present invention that serves to exemplify the various advantages and objects hereof, and are as follows:

FIG. 1 is an illustration for the lubricating structure for a conventional linear guideway;

FIG. 2 is an illustration for the lubricating structure for a conventional linear guideway;

FIG. 3 is an illustration for the lubricating structure for a linear guideway in the present invention; and

FIG. 4 is an illustration for an embodiment that has the linear lubricating structure in the present invention.

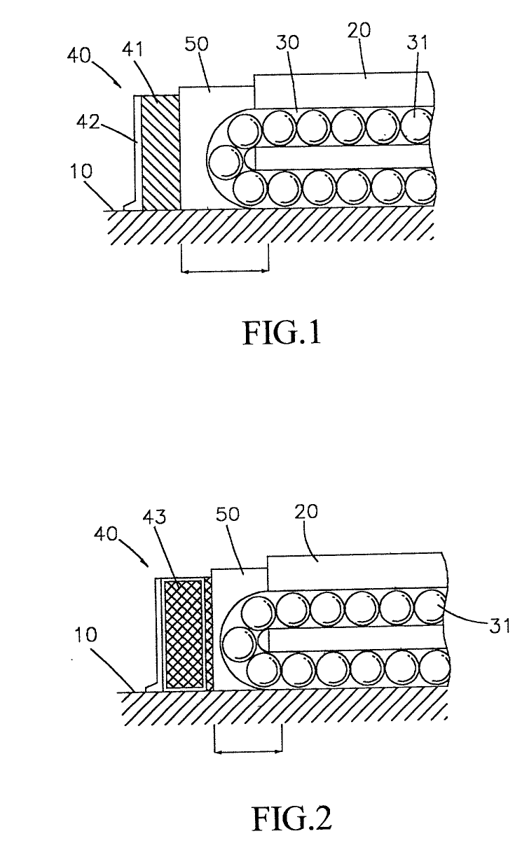

Annotation as follows:

| | | | |
|---|---|---|---|
| 10 | Guideway | 20 | Slider |
| 30 | Slide Way | 31 | Rolling Object |
| 40 | Lubricating Module | 41 | Oil-Containing Substance |
| 42 | Oil-Wiping Blade | 43 | Oil Reservoir |
| 60 | Guideway | 61 | Slider |
| 64 | End Cover | 65 | Oil-Wiping Blade |
| 66 | Sealing Device | 70 | Lubricating Structure |
| 71 | Oil Reservoir | 72 | Diversion Device |

### DETAILED DESCRIPTION OF THE PREFERRED EMBODIMENT

To further understand the characteristics and technical content of the present invention, please refer to the drawings for the present invention. However, the drawings provided are only for references and description, but do not make any limitation on the present invention.

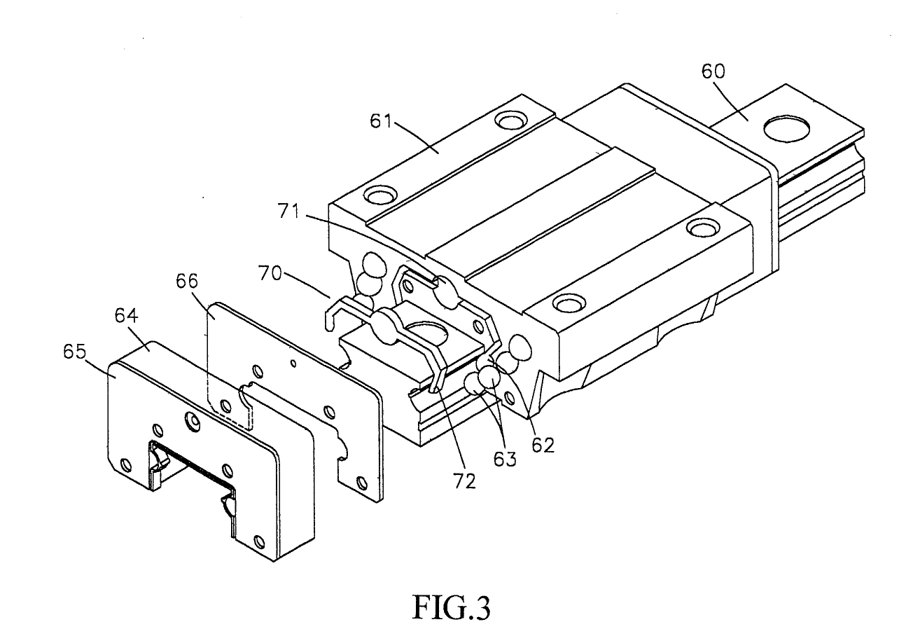

The present invention is mainly to provide an improved structure for linear guideway, as shown in FIG. 3, which in general contains an unlimitedly extendable guideway 60 and a moveable slider 61 along the guideway 60. The slider 61 contains a slide way 62 inside to accommodate rolling objects 63 (maybe a steel ball). Besides, an end cover 64 is installed at one end of the guideway 62 of slider 61 for the rolling objects 63 to circulate. A lubricating structure 70 sits transversely inside the slider 61. The lubricating structure 70 mainly contains an oil reservoir 71 inside the slider 61. The oil reservoir 71 extends along both sides of the slider 61 to connect to the slide way 62. Inside the oil reservoir 71, a diversion device 72 is added (could be any fiber material, like felting). The diversion device 72 is rather tough and long enough for contact with most surface area of the rolling objects 63. A sealing device 66 is installed correspondingly to the oil reservoir 71 on one end of the slider 61. An oil-wiping blade 65 is installed on the outer surface of the end cover 64 to remove contaminants.

Thus, due to the capillarity for the diversion device 72, lubricating oil can be drawn from the oil reservoir 71 in a specific time and contained in the body of the diversion device 72, which when contacting most surface area of the rolling objects 63 will enable all the contacting rolling objects 63 to be covered with the lubricating oil. Besides, it is well known that due to the adsorption induced by the capillarity for the diversion device 72, the lubricating oil is released when the diversion device 72 contacts the rolling objects 63 and is under compression. However, the quantity of the lubricating oil from released the diversion device 72 is not only enough for coating the contacting rolling objects 63, but also several times of the quantity flowable in the slide way 61 (this is similar to a sponge that absorbs soap water for cleaning). Thus, when the slider 61 moves on the guideway 60 at a certain speed, the diversion device 72 constantly introduces the prescribed amount of lubricating oil (controlled by the diversion device 72) to the slide way 62. No matter how far the slider 61 moves, the lubricating oil can flow and coat the rolling objects 63 in a very short time and provide an effective lubrication.

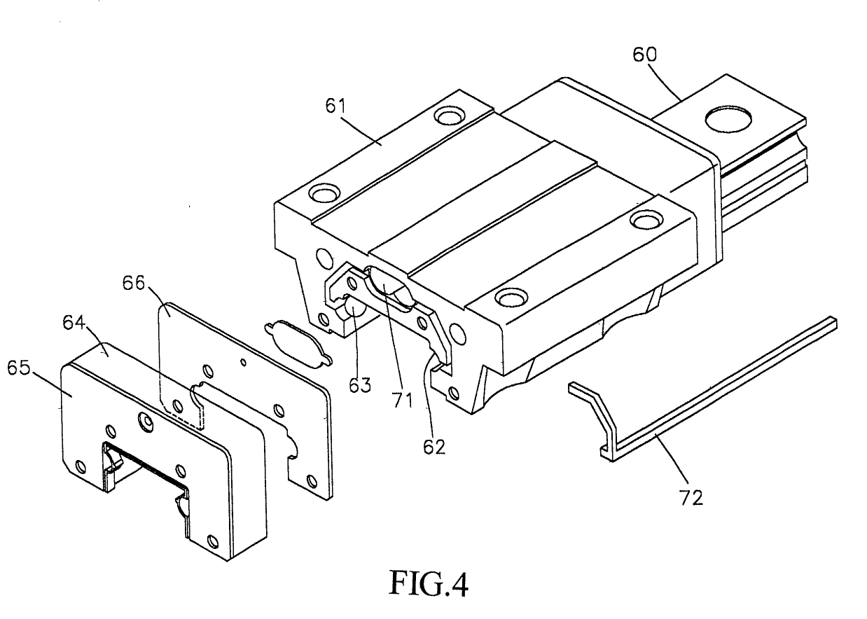

Therefore, to diversify the applications of the present invention, one embodiment of the present invention is provided as shown in FIG. 4, which the diversion device 72 is designed as a structure that extends into the slide way 62 and has the same length of the slide way 62, so it can achieve more efficient lubrication. Certainly, the oil reservoir 71 can be installed outside the slider 61 to reduce the size of the slider 61. The present invention can be broadly used for various types of linear rotary bearing, such as the automatic lubricating devices in other types of linear guideways, for examples, linear guideway, linear ball bush and ball spline.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An improved structure for a linear guideway, containing:
an unlimitedly extendable guideway with a slide way longitudinally;
a moving slider along said guideway with an inside slide way corresponding to above-mentioned slide way of said guideway;
a number of rolling objects moveable on said slide way between said guideway and said slider; and
two end covers installed at both ends of said slider for said rolling objects to circulate;
wherein a lubricating structure is located longitudinally inside said slider and mainly contains an oil reservoir extending to both ends of said slider and connects to said slide way, inside said oil reservoir there is a diversion device tough and long enough for contact with most surface of said rolling objects.

2. The improved structure for a linear guideway of claim 1, wherein said diversion device can be any fiber material.

3. The improved structure for a linear guideway of claim 1, wherein the fiber material is felting.

4. The improved structure for a linear guideway of claim 1, wherein a sealing device is installed at one end of said slider and an oil-wiping blade is installed at outer surface of an end cover.

5. The improved structure for a linear guideway of claim 1, wherein said diversion device is a structure extending into said slide way and having same length with said slide way.

6. The improved structure for a linear guideway of claim 1, wherein said oil reservoir is a structure installed outside said slider and connecting to said slide way through said diversion device.
